(19) United States
(12) Patent Application Publication
(10) Pub. No.: US 2014/0129694 A1
(43) Pub. Date: May 8, 2014

(54) EVALUATING INFORMATION RETRIEVAL SYSTEMS IN REAL-TIME ACROSS DYNAMIC CLUSTERS OF EVIDENCE

(71) Applicants: Adrian Aoun, Seattle, WA (US); Michele Banko, Seattle, WA (US); Guido Bartolucci, Seattle, WA (US); Erik Frey, Seattle, WA (US)

(72) Inventors: Adrian Aoun, Seattle, WA (US); Michele Banko, Seattle, WA (US); Guido Bartolucci, Seattle, WA (US); Erik Frey, Seattle, WA (US)

(73) Assignee: Wavii, Inc., Seattle, WA (US)

(21) Appl. No.: 13/231,627

(22) Filed: Sep. 13, 2011

Related U.S. Application Data
(60) Provisional application No. 61/382,362, filed on Sep. 13, 2010.

(51) Int. Cl. G06F 15/173

(52) U.S. Cl. 709/224

(57) ABSTRACT

A method is disclosed for evaluating an information retrieval system. A performance metric is associated with a message received at the information retrieval system. A geometric point is determined that corresponds to the message based on one or more clustering techniques. The message is assigned to a cluster based on a judgment of a distance between the geometric point and an additional geometric point, the additional geometric point corresponding to an additional message, the additional message being assigned to the cluster. The performance metric is aggregated with an additional performance metric, the additional performance metric corresponding to the additional message. A value is assigned to the cluster, the value representing a ranking of the cluster in comparison to an additional cluster with respect to the performance metric and the additional performance metric.

### CROSS-REFERENCE TO RELATED APPLICATIONS

This application claims the benefit under 35 U.S.C. §119 of U.S. Provisional Application No. 61/382,362, filed Sep. 13, 2010, entitled “EVALUATING AN INFORMATION RETRIEVAL SYSTEM IN REAL-TIME ACROSS DYNAMIC CLUSTERS OF EVIDENCE,” which is incorporated herein by reference in its entirety.

### TECHNICAL FIELD

The present application relates generally to the technical field of implementing information retrieval systems and, in one specific example, to dynamically evaluating information retrieval systems by summarizing their performances across variable clusters of real-time data.

### BACKGROUND

Information retrieval (“IR”) systems may be evaluated by measuring their ability to produce an expected set of answers according to predetermined queries. Corpora of queries and answers may be packaged or shared in order to reliably compare IR systems to each other. This evaluation may produce a metric, such as the ratio of queries the IR system answers correctly relative to the total number of queries, for a corpus of queries and answers. However, this metric may not remain accurate if an IR system is deployed into an environment that is different from environments within which the IR system was initially evaluated.

### BRIEF DESCRIPTION OF THE DRAWINGS

FIG. 1 depicts a block diagram of an example embodiment of a system to evaluate an IR system in real-time across dynamic clusters of evidence.

FIG. 2 depicts a block diagram of an example embodiment of the evaluation engine of the system in more detail.

FIG. 3 depicts a flowchart of an example method to evaluate an IR system in real-time across dynamic clusters of evidence.

FIG. 4 is a block diagram illustrating an example environment in which a system to evaluate an information retrieval system may execute.

FIG. 5 is a block diagram of a machine in the example form of a computer system within which instructions, for causing the machine to perform any one or more of the methodologies discussed herein, may be executed.

### DETAILED DESCRIPTION

In the following description, for purposes of explanation, numerous specific details are set forth in order to provide an understanding of various embodiments of the inventive subject matter. It will be evident, however, to those skilled in the art that embodiments may be practiced without these specific details. Further, well-known instruction instances, protocols, structures, and techniques have not been shown in detail. As used herein, the terms “and” and “or” may be construed in an inclusive or exclusive sense. Additionally, the term “user” may be construed to be a person or a machine.

IR systems that are deployed in dynamic, real-time environments may develop different performance characteristics as the data upon which they operate changes over time. For example, long term changes, such as improvements to an IR system's surrounding dependencies, may render original evaluation corpora stale as a means of evaluating the IR system. Or short term changes, such as a major news event that overwhelms an IR system's input, may contribute to fluctuations in the IR system's performance. Short-term fluctuations may be poorly-represented by a single, overall metric. A single metric may hide important localized performance characteristics that emerge from an IR system that operate on dynamic, non-homogenous data.

Methods and systems described herein may identify localized performance characteristics of one or more IR systems. The identification may depend on the data available to the IR systems. In some embodiments, how performance changes across clusters of entities, such as related locations, people, or things, may be determined or shown. How performance changes across different topics may also be determined or shown. For example, how an IR system performs on all the news articles related to a particular breaking news story may be determined or shown. How performance changes across different classifications in an ontology may also be determined or shown. For example, how the IR system performs on business subjects compared to science subjects may be determined or shown. An evaluation of an IR system in the environment in which the IR system is deployed may be performed. Global, long-term performance metrics may be determined or provided. Clusters of localized performance characteristics within a dynamic, real-time stream of input data may be identified.

In various embodiments, methods and systems are disclosed for evaluating an IR system. A performance metric is associated with a message received at the information retrieval system. A geometric point is determined that corresponds to the message based on one or more clustering techniques. The message is assigned to a cluster based on a judgment of a distance between the geometric point and an additional geometric point, the additional geometric point corresponding to an additional message, the additional message being assigned to the cluster. The performance metric is aggregated with an additional performance metric, the additional performance metric corresponding to the additional message. A value is assigned to the cluster, the value representing a ranking of the cluster in comparison to an additional cluster with respect to the performance metric and the additional performance metric.

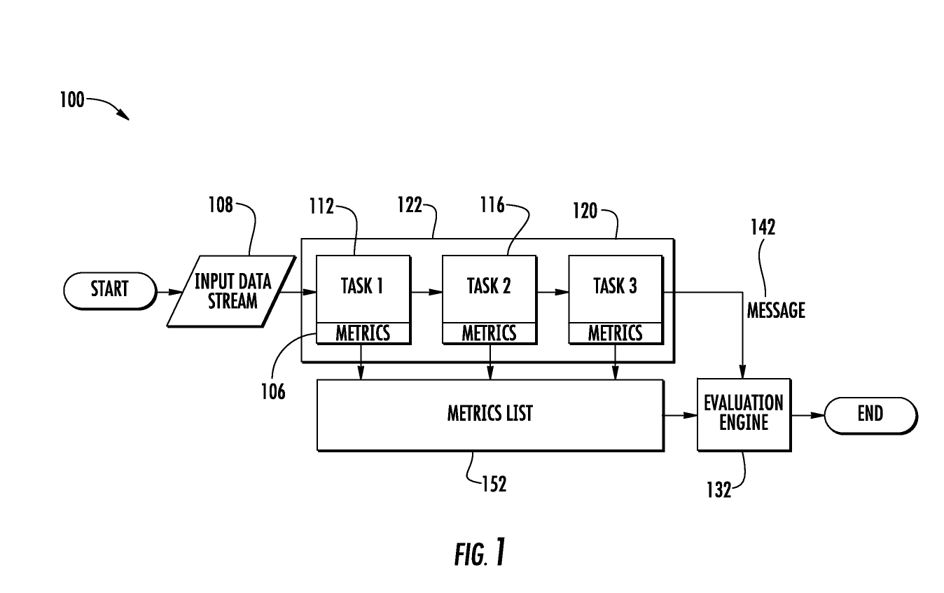

FIG. 1 depicts a block diagram of an example embodiment of a system 100 to evaluate an IR system in real-time across dynamic clusters of evidence. The system 100 includes a metrics tracking module 122. The metrics tracking module 122 includes a series of IR tasks (Task 1 112, Task 2 116, and Task 3 120). The IR tasks operate on an input data stream 108. The input data stream 108 may come from many sources: web sites, syndicated feeds, API data sources, and so forth. Units of work in the input data stream 108 may be described as messages (e.g., message 142), the payloads of which may consist of many media types: pictures, text, audio, and so forth. Although depicted in FIG. 1 as being strung together serially, such that the output of a first task impacts the output of a second task, IR tasks may also operate independently of one another.

A module (e.g., metrics 106) for tracking metrics may be attached to each task processed by the system 100. Examples of performance metrics that may be tracked are total throughput (e.g., a rate of messages passing through an IR task), ratio of adherence to some expected output, the rate of errors, and so forth. Performance metrics may be collected together for each message (e.g., in metrics list 152). The performance metrics may be sent to an evaluation engine 132. The performance metrics may be associated with a message (e.g., message 142) that generated the performance metrics. For example, the performance metrics and the message may be sent to the evaluation engine 132 within such a close proximity of time that an association between the performance metrics and the message is identified.

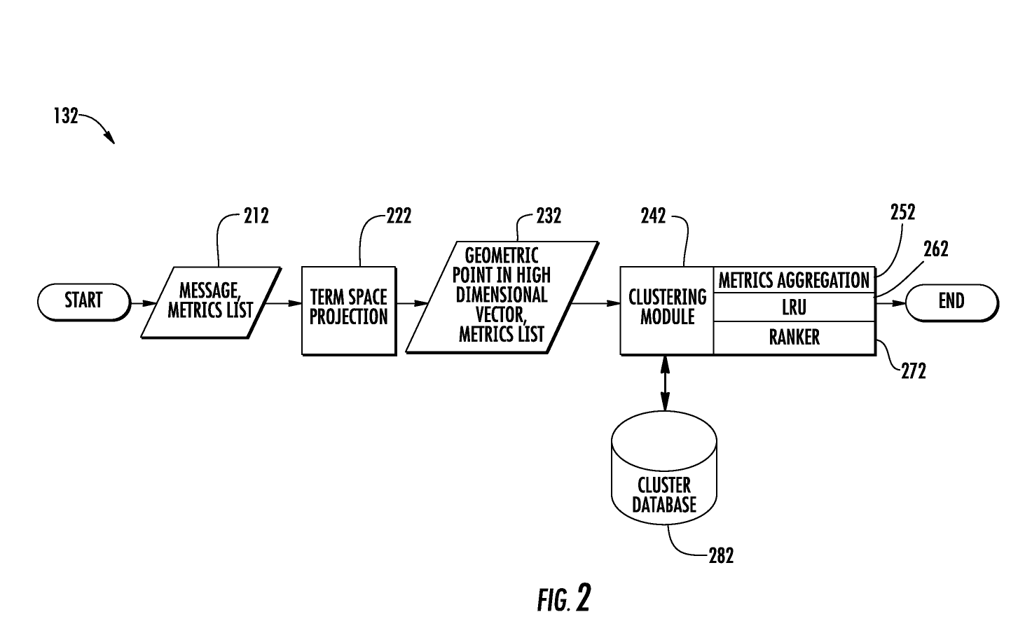

FIG. 2 depicts a block diagram of an example embodiment of the evaluation engine 132 of the system 100 in more detail. Inside the evaluation engine, a term space projection 222 module receives one or more inputs 212. For example, the term space projection 222 module may receive one or more messages (e.g., message 142) or one or more performance metrics (e.g., metrics list 152) as input. The term space projection 222 module may produce one or more outputs 232. For example, the term space projection 222 module may produce a list of terms and numeric weights (e.g., as pairs) as the outputs 232. (A term may be a word that represents something meaningful about the message.) The term space projection 222 module may also produce a point in a high-dimensional space along with a corresponding metrics list as the outputs 232. The high-dimensional space may be represented as a list of indices and weights.

A clustering module 242 is coupled to the term space projection 222 module. The clustering module 242 receives the output(s) of the term space projection module 222 as input(s). The clustering module 242 may analyze the list of terms and numeric weights according to one or more distance metrics and determine that certain lists of terms and numeric weights are close enough (e.g., in distance or relevance) that their associated messages belong to a same cluster. The distance metrics may be cosine or Jaccard distance metrics, but other distance metrics may be used.

A metrics aggregation 252 module is coupled to the clustering module 242. The metrics aggregation 252 module may aggregate and summarize together one or more individual metrics attached to one or more messages in the cluster.

A message cache module (e.g., LRU 262 or least-recently-used message cache module) is contained inside the evaluation engine 132. The message cache module may store a message and decide when to remove it from the message cache module. For example, the message cache module may remove the message because of lack space or lack of access.

A ranker 272 module is associated with the clustering module 242. The ranker 272 module may order one or more clusters according to one or more criteria.

A cluster database 282 is coupled (e.g., communicatively) to the clustering module 242. The clustering module 242 may use the cluster database 282 to store and retrieve data related to the evaluation engine 132.

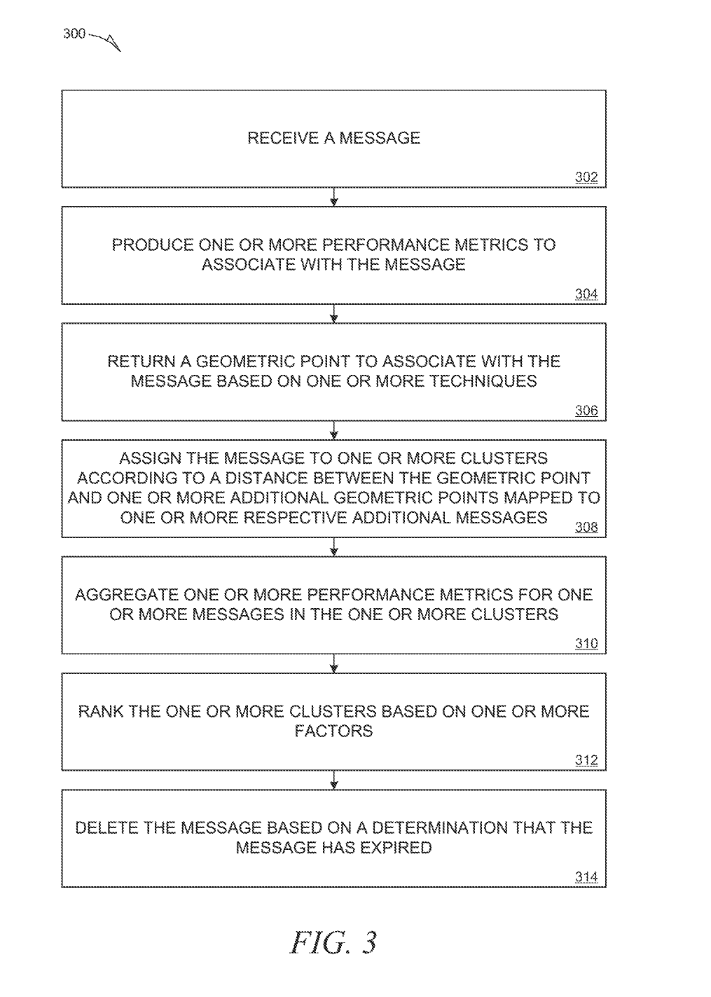

FIG. 3 depicts a flowchart of an example method 300 to evaluate an IR system in real-time across dynamic clusters of evidence. At operation 302, the metrics tracking module 122 receives a message as input and produces a set of metrics as a result. The result metrics may be key value pairs. In an example embodiment, the key may be the name of the metric. In an example embodiment, the value may be a scalar or list. One or more of the metrics may represent raw values that are accumulated in a metrics aggregation module to produce an aggregated metric.

The term space projection 222 module receives the message as input. At operation 306, the term space projection 222 module returns a geometric point as an output. The geometric point may be a set of coordinates in a predefined high-dimensional space. If geometric points are to be clustered by entity, the dimensions may represent the entities in the message. If geometric points are to be clustered by topic, the dimensions may represent topically-significant words within the message. If geometric points are to be clustered by ontological category, the dimensions may represent the result of an ontological mapping function to zero, one, or multiple categories. The term space projection 222 module may use one or more techniques to project messages so that they are more likely to cluster accurately. Examples of such techniques include:

1. Term frequency-inverse document frequency (“tf-idf”) weighting of coordinates in the projection, which evaluates the importance of a particular dimension by measuring how common it is among all the messages being clustered;

2. Named entity recognition, in order to recognize entities in messages such as persons, organizations, locations, expressions of times, quantities, monetary values, and so forth;

3. Ontology mapping functions, which may be the result of supervised machine learning algorithms;

4. Latent semantic analysis, in order to relate terms among the messages together to identify higher level concepts; and

5. Sentence structure analysis, which may include identifying parts of speech, or parsing sentences according to various grammars.

At operation 308, the clustering module 242 receives the geometric point from the term space projection module, and assigns the point to one or more clusters according to a metric for judging the distance between two geometric points, such as Euclidian or cosine distance. The clustering module 242 may rerun an offline algorithm periodically, such as k-means clustering, or it may cluster points in an online fashion, by using a method such as agglomerative clustering. If the clustering module employs an online algorithm like agglomerative clustering, it may include logic for recognizing distinct sub-clusters that have separated within a larger cluster over time, in order to split the cluster or represent the clusters hierarchically.

At operation 310, the metrics aggregation module 252 receives as input one or more metrics of one or more messages in a cluster, and produces therefrom a summary or aggregation of the metrics. For example, the metrics aggregation module 252 may combine together metrics values from distinct messages that belong to the same key. Some aggregations may be simple, like summing together counts, but some may be more complex and involve outside data. For example, performance metrics that express adherence to expected output may use the results of topic clustering to define the expected output during aggregation. Similarly, metrics that were outputted from the metrics tracking module as counts or timestamps may be interpreted within this module as instantaneous rates, or rates over a period of time.

At operation 312, the ranker module 272 receives one or more clusters as input and produces therefrom a value for each of the clusters that is monotonic to the order in which the clusters should be ranked, where the rank signifies importance or relevance at the particular instant that the system is queried. This value may be the result of one or more factors combined linearly or nonlinearly, such as the number of messages that belong to the cluster, the rate at which the cluster is growing or shrinking, and how similar the messages in the cluster are to each other. The value may also be based on heuristics or calculations on the content of the messages, for example, to penalize clusters that appear to contain spam, or to further categorize clusters into higher level ontologies. In other words, the ranker module 272 ranks the one or more clusters based on the one or more factors.

The message cache module 262 monitors every message in the evaluation engine asynchronously. The message cache module 262 may use one or more criteria to decide when to expire a message. The one or more criteria may include the age of the message in the evaluation engine or the total number of messages in the evaluation engine. After the message cache module 262 has decided a message is ready to expire, at operation 314, the message cache module deletes the message from the evaluation engine. The message cache module 262 may also remove the message's statistics from the aggregation for the cluster to which the message belongs.

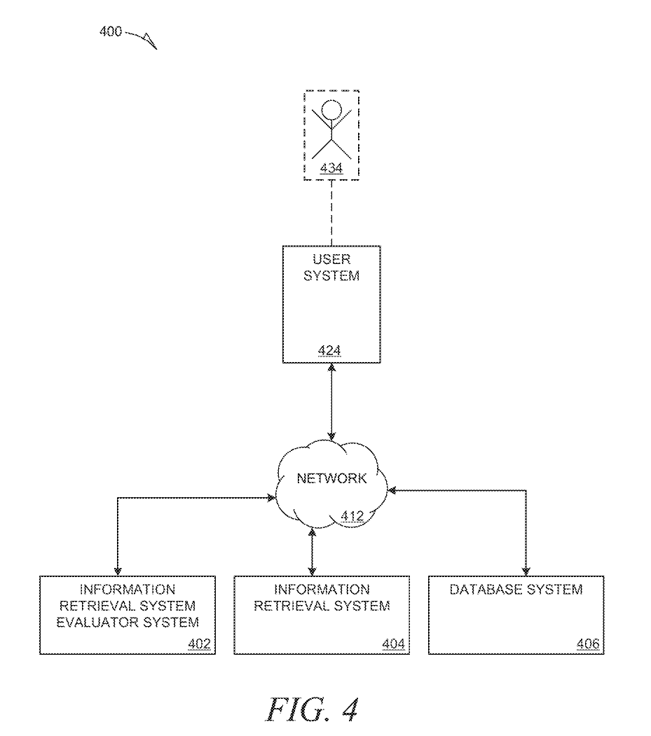

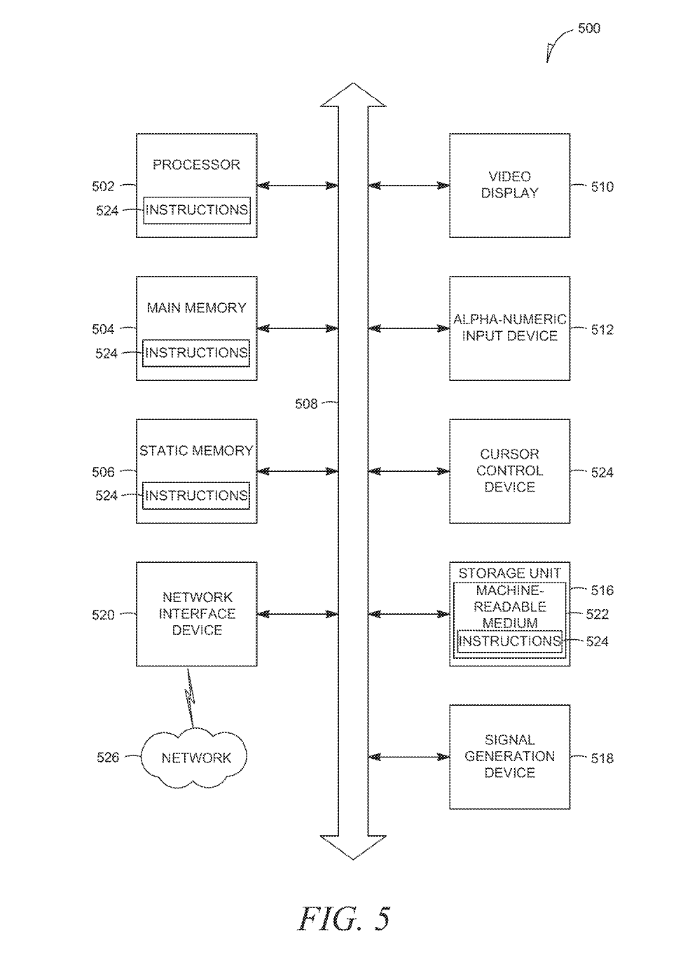

FIG. 4 is a block diagram illustrating an example environment 400 in which a system to evaluate an information retrieval system may execute. The environment 400 may include an information retrieval system evaluator system 402 (e.g., the system of FIG. 1), an information retrieval system 404, a database system 406, a user system 424, and a user 434. Information retrieval system 404 may retrieve or otherwise receive various types of input data (e.g., text, multimedia, images) corresponding to a variety of content (e.g., articles or publications, videos, audio clips, transaction data, data sets) from a variety of data sources. It is contemplated that the particular types of input data and content capable of being retrieved by the information retrieval system 404 should not be construed as limited to the examples discussed herein. In an example embodiment, information retrieval system 404 may store and access retrieved data in database system 406. Any of the systems 402, 404, 406, 424 may be one or more machines (e.g., the machine of FIG. 5, discussed below). The user 434 may be a user of any of the systems 402, 404, 406, or 424. Additionally, the user 434 may be a person or a machine.

The user 434 may access the information retrieval system evaluator system 402 to obtain an evaluation of the information retrieval system 404 with respect to particular performance metrics or with regard to the processing of particular kinds of information. The information retrieval system evaluator system 402, the information retrieval system 406, the database system 406, or the user system 424 may be connected via the network 412. For example, the user 434 may access a system (e.g., the information retrieval system evaluator system 402) using a web browser application (e.g., Windows® Internet Explorer®) executing on a personal computer. In response, the user 434 may be able to request or obtain an evaluation of one or more information retrieval systems (e.g., information retrieval system 404). Additionally, the user may be able to access the information retrieval system evaluator system 402 to configure the information retrieval evaluator system 402 to track the performance of one or more information retrieval systems (e.g., information retrieval system 404) with respect particular performance metrics or particular kinds of information.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).) Network 412 of FIG. 4 is an example of a network over which such operations may be executed.

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

FIG. 5 is a block diagram of a machine in the example form of a computer system 500 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a user interface (UI) navigation (or cursor control) device 514 (e.g., a mouse), a disk drive unit 516, a signal generation device 518 (e.g., a speaker) and a network interface device 520.

The disk drive unit 516 includes a machine-readable medium 522 on which is stored one or more sets of instructions and data structures (e.g., software) 524 embodying or utilized by any one or more of the methodologies or functions described herein. The instructions 524 may also reside, completely or at least partially, within the main memory 504 and/or within the processor 502 during execution thereof by the computer system 500, the main memory 504 and the processor 502 also constituting machine-readable media. The instructions 524 may also reside, completely or at least partially, within the static memory 506.

While the machine-readable medium 522 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

The instructions 524 may further be transmitted or received over a communications network 526 using a transmission medium. The instructions 524 may be transmitted using the network interface device 520 and any one of a number of well-known transfer protocols (e.g., Hyper Text Transfer Protocol or HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1-2. (canceled)

3. A computer-implemented method comprising:
receiving a message having content;
assigning the message to a cluster of messages based on the content of the message;
determining, for a metric associated with a performance of an information retrieval system in performing a particular task of a series of information retrieval tasks that operate on an input data stream of messages, a metric value for the message; and
aggregating, by one or more computers and for the metric associated with the performance of the information retrieval system, the metric value for the message with one or more corresponding metric values for one or more other messages that are also assigned to the cluster of messages.

4. The method of claim 3, comprising:
receiving data indicating a request regarding the metric or the cluster of messages; and
in response to receiving data indicating a request regarding the metric or the cluster of messages, providing a representation of the aggregated metric value for output.

5. The method of claim 4, wherein the representation of the aggregated metric value comprises a rank of the cluster of messages, among one or more other clusters, for the performance metric.

6. The method of claim 4, comprising:
before receiving the data indicating a request regarding the performance metric or the cluster of messages, determining that a particular message assigned to the cluster of messages has expired; and
removing the metric value for the particular message that has expired from the aggregated metric value for the cluster of messages.

7. (canceled)

8. The method of claim 3, wherein the metric associated with the performance of the information retrieval system comprises a rate of messages passing through processing by the information retrieval system, or a ratio of adherence to an expected output.

9. The method of claim 3, wherein assigning the message to a cluster of messages based on the content of the message comprises:
generating a vector for the message, wherein each component of the vector represents a numeric value associated with a term corresponding with the content of the message; and
determining that the vector for the message is close in distance to corresponding vectors for the one or more other messages in the cluster of messages.

10. The method of claim 9, comprising:
for each component of the vector, weighting the numeric value based on a term frequency-inverse document frequency analysis of the associated term.

11. The method of claim 9, wherein the terms comprise entities that are identified from the content of the message.

12. The method of claim 3, wherein aggregating the metric value for the message with one or more corresponding metric values for one or more other messages that are also assigned to the cluster of messages comprises summing the metric value with the corresponding metric values.

13. A computer readable storage device encoded with a computer program, the program comprising instructions that, if executed by one or more computers, cause the one or more computers to perform operations comprising:
receiving a message having content;
assigning the message to a cluster of messages based on the content of the message;
determining, for a metric associated with a performance of an information retrieval system in performing a particular task of a series of information retrieval tasks that operate on an input data stream of messages, a metric value for the message; and
aggregating, for the metric associated with the performance of the information retrieval system, the metric value for the message with one or more corresponding metric values for one or more other messages that are also assigned to the cluster of messages.

14. The device of claim 13, wherein the operations comprise:
receiving data indicating a request regarding the metric or the cluster of messages; and
in response to receiving data indicating a request regarding the metric or the cluster of messages, providing a representation of the aggregated metric value for output.

15. The device of claim 14, wherein the representation of the aggregated metric value comprises a rank of the cluster of messages, among one or more other clusters, for the performance metric.

16. The device of claim 14, wherein the operations comprise:
before receiving the data indicating a request regarding the performance metric or the cluster of messages, determining that a particular message assigned to the cluster of messages has expired; and
removing the metric value for the particular message that has expired from the aggregated metric value for the cluster of messages.

17. (canceled)

18. The device of claim 13, wherein the metric associated with the performance of the information retrieval system comprises a rate of messages passing through processing by the information retrieval system, or a ratio of adherence to an expected output.

19. The device of claim 13, wherein assigning the message to a cluster of messages based on the content of the message comprises:
generating a vector for the message, wherein each component of the vector represents a numeric value associated with a term corresponding with the content of the message; and
determining that the vector for the message is close in distance to corresponding vectors for the one or more other messages in the cluster of messages.

20. The device of claim 19, wherein the operations comprise:
for each component of the vector, weighting the numeric value based on a term frequency-inverse document frequency analysis of the associated term.

21. The device of claim 19, wherein the terms comprise entities that are identified from the content of the message.

22. A system comprising:
one or more computers and one or more storage devices storing instructions that are operable, when executed by the one or more computers, to cause the one or more computers to perform operations comprising:
receiving a message having content;
assigning the message to a cluster of messages based on the content of the message;
determining, for a metric associated with a performance of an information retrieval system in performing a particular task of a series of information retrieval tasks that operate on an input data stream of messages, a metric value for the message; and
aggregating, for the metric associated with the performance of the information retrieval system, the metric value for the message with one or more corresponding metric values for one or more other messages that are also assigned to the cluster of messages.

23. The system of claim 22, wherein assigning the message to a cluster of messages based on the content of the messages message comprises:
generating a vector for the message, wherein each component of the vector represents a numeric value associated with a term corresponding with the content of the message; and
determining that the vector for the message is close in distance to corresponding vectors for the one or more other messages in the cluster of messages.

24. The system of claim 23, wherein the operations comprise:
for each component of the vector, weighting the numeric value based on a term frequency-inverse document frequency analysis of the associated term.
